(19) United States
(12) Patent Application Publication
(10) Pub. No.: US 2022/0274296 A1
(43) Pub. Date: Sep. 1, 2022

(54) DEVICE AND METHOD FOR LOADING PREFABRICATED PARTS INTO A MOLDING TOOL OF A PRESS, AS WELL AS A PRESS COMPRISING SUCH A DEVICE

(71) Applicant: Wickert Maschinenbau GmbH, Landau (DE)

(72) Inventors: Florian SCHRAMM, Wernersberg (DE); Stefan HERTEL, Gleisweiler (DE)

(73) Assignee: Wickert Maschinenbau GmbH, Landau (DE)

(21) Appl. No.: 17/684,066

(22) Filed: Mar. 1, 2022

(30) Foreign Application Priority Data
Mar. 1, 2021 (DE) 20 2021 101 012.6

(51) Int. Cl. B29C 43/34; B29C 43/02; B29C 43/36

(52) U.S. Cl. CPC B29C 43/34; B29C 43/02; B29C 43/36; B29K 2021/00

(57) ABSTRACT

A device and a method for loading prefabricated parts into a molding tool of a press for the production of molded parts, in particular for the production of elastomer molded parts. For this purpose, the device comprises a plate-like carrier element with a top and a bottom intended for attachment on or to the press and a holding device for accommodating at least one interchangeable platen equipped with the parts. The holding unit is arranged on the supporting element at a clear distance from its bottom and the interchangeable platen comprises a plurality of passage openings to accommodate the parts. Furthermore, the device comprises a platen with pins which are arranged between the bottom of the supporting element and the holding unit, wherein the pins align with the passage openings.

This nonprovisional application claims priority under 35 U.S.C. § 119(a) to German Patent Application No. 20 2021 101 012.6, which was filed in Germany on Mar. 1, 2021, and which is herein incorporated by reference.

### BACKGROUND OF THE INVENTION

### Field of the Invention

The present invention relates to a device for loading prefabricated parts into a molding tool of a press for the production of molded parts, in particular elastomer molded parts, a press comprising such a device and a method for loading prefabricated parts into a molding tool of a press for the production of molded parts.

### Description of the Background Art

In the production of molded parts in presses, a flowable mass such as rubber or plastic is pressed into a molding tool and is converted into a dimensionally stable state by vulcanization or cooling. After opening the molding tool, the finished molded part can be removed. To extend the functionality, the molded part may also contain one or more prefabricated parts that become an integral part of the molded part during production in the molding tool.

As an example, drug vials seals may be mentioned, which usually are formed of a rubber stopper and ensure that no drug penetrates from the vial. The end face of the rubber stopper situated in the neck of the vial is the surface that is wetted with drugs, a fact which carries the risk of contaminating the drug due to chemical reactions between the drugs and the rubber.

To prevent this, it is known from WO 84/03682 to coat the surface of the rubber stopper which is in contact with the drug with a chemically inert material. For this purpose, a layer of a thermoplastic and a layer of a rubber are placed between the upper part and the lower part of an open molding tool, the molding tool is closed and supplied with heat. In the course of vulcanizing the rubber, the inert layer combines with the rubber and becomes an integral part of the rubber stopper.

Problems arise when the rubber stopper is to be coated not only on its front end, but also over part of the subsequent plug circumference. If the inert layer is formed of inelastic materials, their three-dimensional deformation in the molding tool leads to the formation of wrinkles and consequently to poor tightness of the seal. For this reason, WO 84/03682 proposes that the inert layer should be formed of an elastic material.

Due to its chemically inert properties and thermal resistance, polytetrafluoroethylene (PTFE) has proven to be a suitable material for coating the surfaces of a vial seal wetted by the drug. The use of this material in the manufacture of elastomeric sealing plugs for drugs and a corresponding device is described in U.S. Pat. No. 4,397,903. There, circular discs are punched out from a strip of two-layer material comprising a chemically inert layer and a rubber layer and, in a subsequent step, forced into hole-shaped receptacles of an interchangeable platen. An interchangeable platen fully equipped with parts is then placed over the lower half of the mold of a molding tool, wherein the parts come to rest above the cavities of the lower half of the mold. With the help of a platen that can be lowered onto the interchangeable platen or mold and is studded with pins, the individual parts are then pressed into the cavities assigned to them. After removing the interchangeable platen, the molding tool is closed, rubber is forced into the cavities and vulcanized under the influence of heat, wherein the parts are bonded to the elastomer of the molded part.

In sensitive fields of application, such as pharmaceuticals, very high demands are placed on the quality of the finished molded parts. In the case of the described vial seals, this includes not only an absolute tightness of the seal but also the exact positioning of the inert coating on the seal, to be able to reliably avoid comprising the drug due to chemical reactions with the seal material.

### SUMMARY OF THE INVENTION

It is therefore an object of the present invention to provide a device, a press, and a method by which, taking into account economic considerations, molded parts can be produced which meet even the highest requirements in terms of function, chemical resistance, and the like.

The invention is based, among other things, on the idea of lowering the pins of a device according to the invention in two stages, wherein in a first step the pins are lowered from a first position onto the interchangeable platen equipped with parts only until an intermediate position is reached in which the parts are secured by the pins in or on the interchangeable platen. In this intermediate position, the pins occupy a position with respect to the parts in which the pins maintain a minimum distance from the parts or make contact with the parts without exerting any significant force on the parts. After transferring the device to the press, the pins are lowered further until a second position is reached, wherein the parts are pressed from the interchangeable platen and loaded into the cavities of a molding tool. This has the great advantage that the parts cannot slip on the interchangeable platen or fall off the interchangeable platen when the inventive device is handled. Thus, disturbances in the operating sequence caused thereby are avoided so that the manufacturing process according to the invention runs more smoothly, more efficiently and more economically.

The achieved positional securing of the parts in the target position after the first lowering of the pins also means that the position of the parts no longer changes, and the parts can therefore be loaded into the cavities with high precision. The quality of the molded parts produced according to the invention with regard to form and function improves considerably with the further advantage that the proportion of rejects is negligible. As a result, thanks to the invention, high-quality molded parts can be produced extremely economically.

Preferably, the drive for lowering the platen with the pins comprises a lowering device comprising one or more actuators, for example hydraulic and/or pneumatic cylinder piston units and/or electromechanical actuators such as spindle drives and the like, which, in a simple embodiment of the invention and by suitable control of the actuators, interrupt their actuating path and thus the lowering movement as soon as the platen has reached the intermediate position.

The at least one actuator can be formed by two cylinder piston units, which are functionally connected in series in such a way that the one cylinder piston unit provides the lowering process from the first position of the platen to the intermediate position and the other cylinder piston unit provides the lowering process from the intermediate position to the second position. For example, for this purpose, two cylinder piston units may be coupled in such a way that their piston strokes add up, wherein the piston stroke of one cylinder piston unit provides the first lowering operation, and the piston stroke of the other cylinder piston unit provides the second lowering operation. In this way, the platen with the pins can be quickly, accurately, and reliably brought into the intermediate position.

The lowering device for lowering or lifting the platen can comprise at least one, preferably a plurality of pressure modules, wherein a pressure module comprises a push rod, which is moveable in the lowering direction, the one end of which is force-locked to the platen and the other end of which is directly connected to the actuator in a simple embodiment and is operated by it. In this embodiment, the push rod may also be formed directly by the piston rod of a cylinder piston unit or a spindle of a spindle drive.

The actuator of the lowering device can act on the one lever arm of a rotatably mounted rocker arm, the other lever arm of which actuates the push rod in the course of the rotational movement. Due to the radially moveable articulation of the push rod on the other lever, during conversion of the rotary movement of the rocker arm into a linear movement of the push rod, kinematic dependencies result in a rapid lowering of the platen into the intermediate position and an increase in the lowering force when the platen is lowered from the intermediate position into the second position during expression of parts from the interchangeable platen or impression of the same into cavities of the molding tool.

The lowering device comprises multiple pressure modules, the movement of which is synchronized when lowering the platen in order to achieve a uniform lowering of the platen over the surface and thus a uniform lowering of the pins onto the interchangeable platen. Appropriate synchronizators for the purposes of the invention may, for example, be rotatably mounted shafts, wherein the rocker arms of two pressure modules sit torque-proof on the same shaft. Several shafts can be synchronized via one-sided levers and rods hinged to them. Preferably, each corner area of the platen is assigned a pressure module, which is driven and synchronized in pairs via a common shaft. The synchronization of the two pressure module pairs is then carried out by movement coupling of the two shafts.

The pins can be attached directly to the platen. However, in order to be able to adapt the platen to different interchangeable platens with different passage opening patterns, the pins are mounted in a preferred embodiment on carrier plates, which can be attached to the platen in a detachable and interchangeable manner. In this way, different carrier plates can be kept available, selected depending on the interchangeable platen used and loaded into the platen, resulting in an extremely variable inventive device in terms of the range of application. Preferably, the carrier plates correspond in number, shape, and size to the interchangeable platens.

The exact positioning of the interchangeable platens equipped with parts above the cavities of the molding tool has a direct effect on the quality of the molded parts to be manufactured. In this context, an advantageous embodiment of the invention comprises supporting elements that engage in bores on the press or the molding tool when the device is set down. By radial expansion of expansion elements within the bore, the device is fixed and centered with respect to the press.

The centering of the interchangeable platen with respect to the molding tool is carried out by at least two centering pins, which project from the bottom of the interchangeable platen and engage in fitting bores on the molding tool when the device is lowered. In order to take into account an expansion of the device components pressurized with temperature during the lowering process, it is provided in advantageous further development of the invention that the at least two, preferably at least three centering pins also project from the top of the interchangeable platen and extend into openings in the platen or carrier plate. The openings are each formed as a slotted hole, so that a relative movement between centering pins and platen or carrier plate in the direction of the slotted hole is possible. The longitudinal extension direction of a slotted hole points to the center of the platen or carrier plate, so that changes in length as a result of temperature changes occur from the center evenly in all directions, which increases the precision with which the pins are centered over the passage openings of the interchangeable platen.

Comparable to this, the at least two, preferably at least three centering pins can also extend through slotted holes in the interchangeable platen, the longitudinal extension direction of which points, as described, to the center of an interchangeable platen. By the arrangement of at least two, preferably at least three such centering pins and slotted holes per interchangeable platen, a uniform expansion on the surface of the interchangeable platen can be achieved when the interchangeable platen is placed onto a heated molding tool.

Without limiting itself thereto, the invention is explained in more detail below on the basis of an embodiment example presented in the drawings, wherein further features and advantages of the invention are apparent. The embodiment example concerns the production of elastomer plugs with PTFE coating as a seal for drug vials. Other material pairings of elastomers, plastics, metals, and the like fall within the scope of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an oblique view of a device according to the invention without interchangeable plates;

FIG. 2 is a section through the device shown in FIG. 1 in the xz-plane along line II-II shown in FIG. 3, with the platen in an upper first position;

FIG. 3 is a section through the device shown in FIG. 1 in the yz-plane along line III-III shown in FIG. 2, with the platen in the upper first position;

FIG. 4 is a section through the device shown in FIG. 1 in the yz-plane for line IV-IV shown in FIG. 2, with the platen in an intermediate position; and

FIG. 5 is a section through the device shown in FIG. 1 in the yz-plane along the line V-V shown in FIG. 2, with the platen in a lower second position.

### DETAILED DESCRIPTION

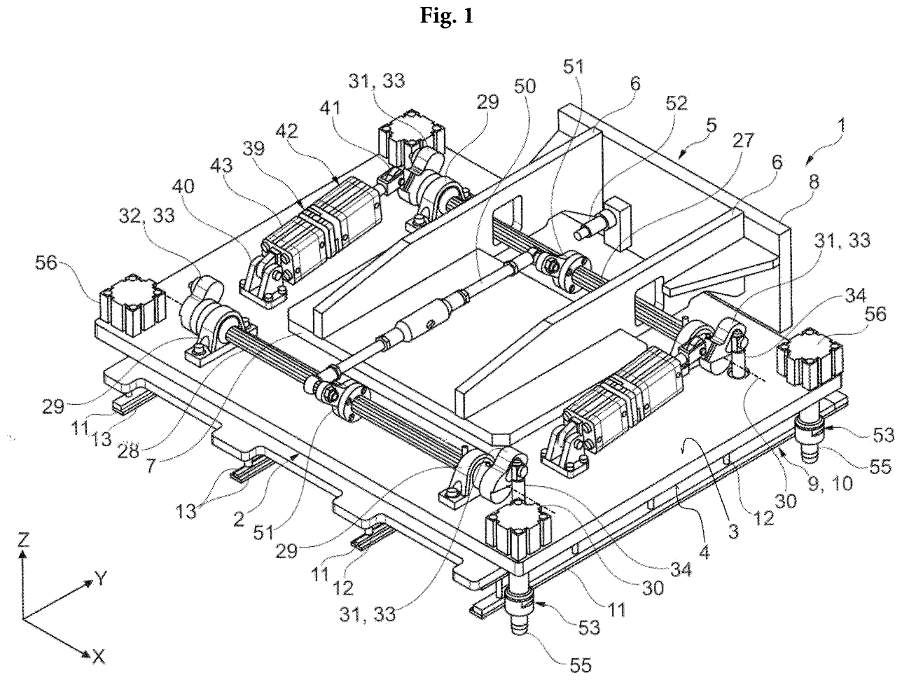

FIG. 1 gives an overview of the basic structure of an inventive device 1 without showing the interchangeable platens 14. The supporting structure of the device 1 comprises a rectangular plate-shaped and, during the operation of the device 1, approximately horizontally aligned carrier element 2 with a flat top 3 and parallel bottom 4, as well as a holder 5 for attaching the device 1 to a press, not further shown, of a collaborative robot, manipulator, or the like. The holder 5 comprises two parallel holding arms 6, which extend with their ends into the center area of the carrier element 1 and there together support a rectangular mounting plate 7, which in turn is force-locked to the top 3 of the supporting element 2. The opposite ends of the holding arms 6 lead to a common connection plate 8, which is used to attach the device 1.

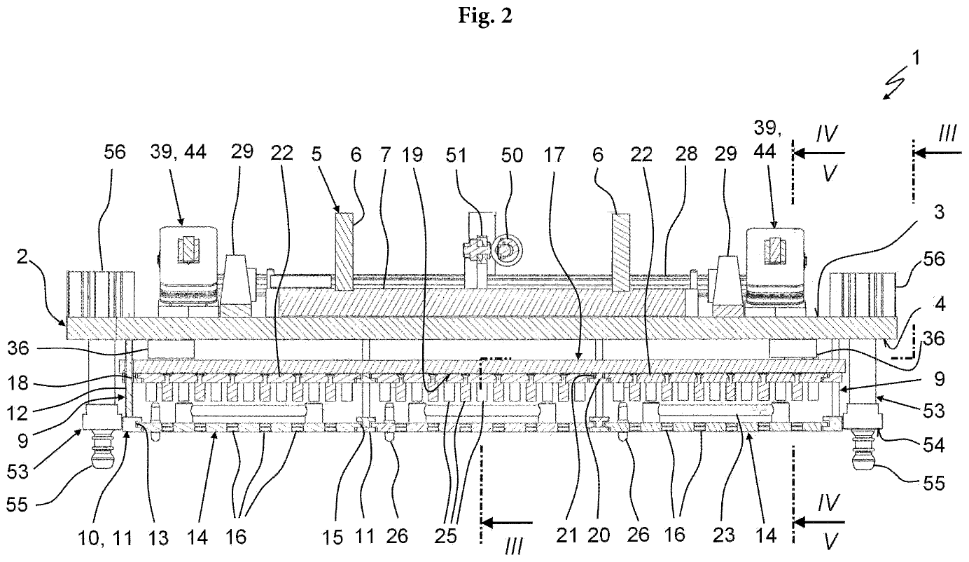

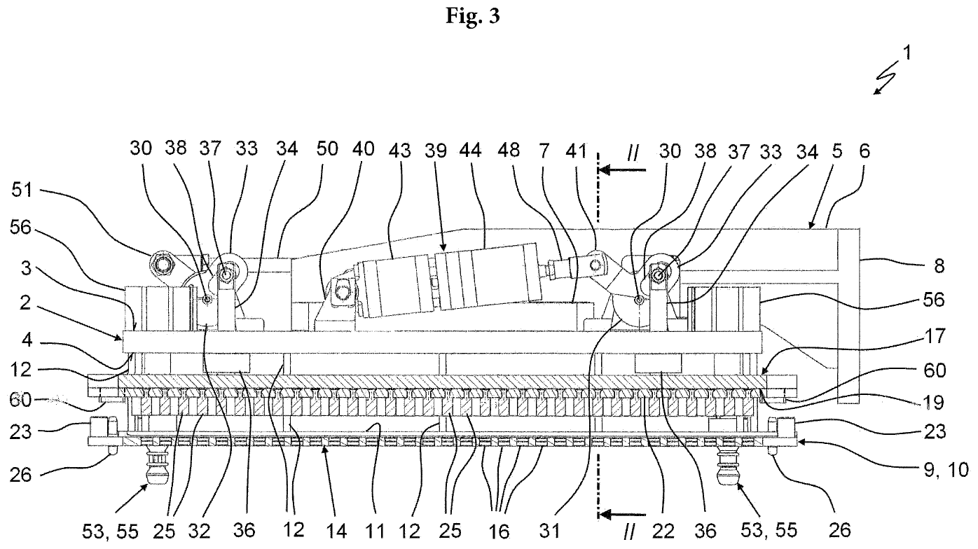

As can be seen in particular from FIGS. 2 and 3, the device according to the invention 1 also comprises a holding device 9, which is arranged at a clear distance to the bottom 4 in a plane-parallel position to it. The holding device 9 substantially includes a support frame 10 with support profiles 11 running at a mutual distance in the y-direction, which are suspended over their length by means of several vertical rods 12 on the supporting element 2. On the longitudinal sides facing each other, the support profiles 11 each comprise a longitudinal groove 13, wherein a pair of opposing longitudinal grooves 13 form a receptacle and guide for loading interchangeable platens 14, which is described in more detail below. The support frame 10 also comprises a transverse profile which connects the support profiles 11 at their end facing the connection plate 8 and which forms a stop for the interchangeable platens 14 to limit the loading depth.

In the present embodiment, the support frame 10 of the device 1 comprises four parallel support profiles 11, which are distributed at a uniform distance from each other over the entire width in the x-direction and between them accommodate three identical interchangeable platens 14. The interchangeable platens 14 are mounted floating with play in the support frame 10.

Each interchangeable platen 14 has a rectangular shape, wherein along its longitudinal edges there is a strip-shaped projection 15 which engages in the longitudinal groove 13 when loading an interchangeable platen 14 into the holding device 9. Across its surface, an interchangeable platen 14 is equipped with a plurality of passage openings 16, which, over their depth, can be designed cylindrical, conical, stepped or the like, and each of which form a receptacle for a part to be loaded into the mold of a molding tool.

At two opposite corner areas, each interchangeable platen 14 is penetrated by a rigid centering pin 26, which forms a protrusion upwards and downwards beyond the interchangeable platen 14. With its lower protrusion, the centering pin 26 engages in existing fitting holes in a molding tool 57 when placing the device 1 on the latter in order to center the interchangeable platen 14 with respect to the molding tool 57. For ease of handling, each interchangeable platen 14 is equipped on its two narrow edges with a handle 23.

The device 1 further comprises a platen 17, which is arranged in the area between the bottom 4 of the supporting element 2 and the holding device 9. The platen 17 also has a rectangular shape and is mounted vertically moveably on the device 1 and approximately congruently to the holding device 9. For this purpose, the platen 17 comprises passage openings 18, which align with the rods 12 of the holding device 9 and are interspersed with them. In this way, the rods 12 form vertical guides along which the platen 17 can be lowered to the holding device 9 comprising the interchangeable platens 14 or lifted therefrom.

On the bottom 19 of the platen 17, in a congruent position to the supporting profiles 11 of the support frame 10, profile rails 20 are fastened which, comparable to the support profiles 11 at their mutually facing longitudinal edges, each form a longitudinal groove 21 resulting in receptacles for accommodating support plates 22. The support plates 22 essentially correspond in their dimensions to the interchangeable platens 14 and, after loading, float with play between two profile rails 20, the upper side of which faces the bottom 19 of the platen 17. Edge stops and spring-loaded fixes hold the support plates 22 in the intended position with respect to the platen 17, and thus within the device 1.

On their bottoms facing the interchangeable platens 14, the support plates 22 comprise a plurality of pins 25 which protrude vertically from the plane of the support plates 22 in the direction of the interchangeable platens 14. The arrangement of the pins 25 corresponds to the arrangement of the passage openings 16, i.e., the pins 25 are aligned with the passage openings 16 such that when lowering the platen 17, the pins 25 penetrate into the passage openings 16. In order to allow for a certain play of the pins 25 in the passage openings 16, the diameter of the pins 25 is smaller than the diameter of the passage openings 16.

The lowering of the platen 17 with pins 25 onto the interchangeable platens 14, or their lifting, is carried out with the help of a lowering device, of which the drive and other components are mainly arranged on the top 3 of the supporting element 2. As can be seen from a compilation of FIGS. 1 to 3, the lowering device comprises a first shaft 27 and second shaft 28, which are held axis parallel to the x-axis and at a lateral distance from each other in bearings 29, in each case rotatable about an axis 30. On each end of the two shafts 27, 28 and thus in the corner areas of the supporting element 2, is a torque-proof lever, for the first shaft 27 in each case a rocker arm 31, and for the second shaft 28 in each case a one-sided lever 32, which each act with their one lever arm 33 on a push rod 34 which, as part of a force-transmitting pressure module, ensures the movement of the platen 17 perpendicular to the supporting element 2.

For this purpose, each push rod 34 is guided longitudinally in a bearing bushing 35, which intersperses the supporting element 2 in the z-direction. The bearing bushing 35 has a widened foot 36 at the bottom 4 of the supporting element 2, which with its flat bottom represents an upper stop for the platen 17. The lower end of the push rod 34 non-positively integrates into the platen 17; the upper end, on the other hand, is jointly connected to the one lever arm 33, wherein the hinge point 37 in a radial slot 38 in the lever arm 33 is forcibly guided radially moveably with respect to the axis 30 to convert the rotational movement of the one lever arm 33 about the axis 30 into a linear movement of the push rod 34 in or against the z-direction.

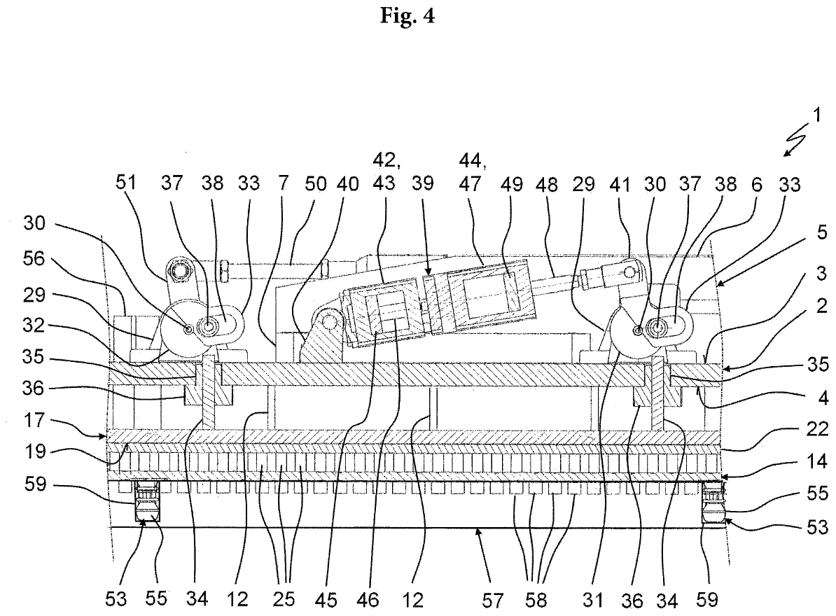

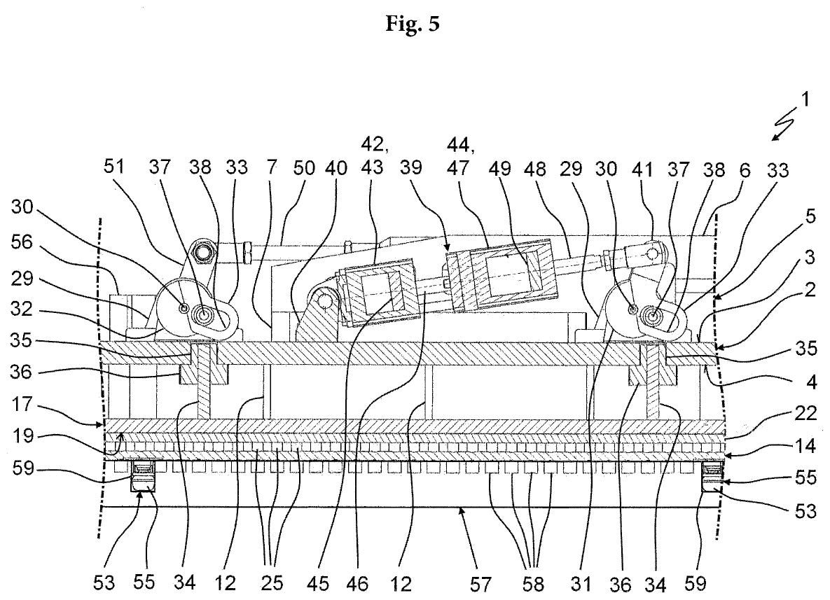

The drive for turning the first shaft 27 about the axis 30 and thus the rocker arm 31 comprises a pair of linear actuators 39, each of which extend between a bearing bracket 40 attached to the top 2 of the supporting element 2 as a fixed bearing and the other lever arm 41 of the rocker arm 31. Each linear actuator 39 is formed of a first cylinder piston unit 43 and a second cylinder piston unit 44, which are arranged linearly in series. In the present embodiment, this means that the cylinder 42 of the first cylinder piston unit 43 is hinged at the bearing bracket 40, and the movable piston 45 of the first cylinder piston unit 43 supports the cylinder 47 of the second cylinder piston unit 44 with its piston rod 46. The piston rod 48 of the movable piston 49 of the second cylinder piston unit 44 is hinged to the second lever arm 41 of the rocker arm 31 (FIG. 4 and FIG. 5).

For the transfer and synchronization of the rotational movement of the first shaft 27 to the second shaft 28, a one-sided lever 51 sits torque-proof on both shafts 27, 28 between the bearings 29. A tension-compression rod 50 hinges with its ends to the two levers 51. A proximity switch 52 in the pendulum range of the tension-compression rod 50 limits the rotational movement of the shafts 27, 28.

For the precise placement of the device 1 over the mold of a press, the device 1 comprises at each corner a supporting element 53 extending from the carrier element 2 downwards against the z-direction, whose widened foot with its flat bottom forms a height-defined contact surface 54. In axial extension of the supporting element 53, an expansion element 55 protrudes from the contact surface 54, which expansion element, in the case of axial compression, experiences a uniform radial elongation over the circumference. The axial compression of the expansion element 55 is achieved by means of an actuating rod running inside the supporting element 53, which can be tensioned or relaxed by means of cylinder piston units 56 arranged at the top 2 of the carrier element 2.

The method according to the invention for loading prefabricated parts into a molding tool of a press in the production of molded parts with the help of the device 1 described above is explained below in more detail with additional reference made to FIGS. 4 and 5.

Initially, the device 1 according to the invention is in a first operating position, as reproduced in FIGS. 1 to 3, in which the platen 17 with pins 25 is in the upper first position and the holding device 9 for accommodating the interchangeable platens 14 is ready. The cylinder piston units 43, 44 of the two actuators 39 are in a retracted state at this time (FIG. 1).

In a next step, the interchangeable platens 14, which are equipped with parts outside the device 1, are loaded into the holding device 9, wherein the passage openings 16 with parts lying therein are aligned with the pins 25 (FIG. 2 and FIG. 3).

The second operating position of the device 1 is achieved after subsequent activation of the second cylinder piston unit 44 in that the two rocker arms 31 are rotated on the first shaft 27 by a first dimension about the axis 30. Via the tension-compression rod 50, the rotational movement of the first shaft 27 is synchronously transferred to the second shaft 28 and subsequently to the one-sided lever 32. Rocker arm 31 or one-sided lever 32 push the push rods 34 by a first dimension in the direction against the z-direction downwards until the platen 17 has reached an intermediate position in which the pins 25 with their ends secure the parts in the passage openings 16 in their position.

In this state, the device 1 is placed over the mold 57 of a molding tool of a press, which is shown in FIG. 4. You can see the form 57 of a molding tool, shown only in a simplified manner, with upwardly open cavities 58 and blind bores 59. When placing the device 1 on the mold 57, the supporting elements 53 are inserted into the blind bores 59 until the contact surfaces 54 rest on the mold 57. With the help of the expansion elements 55 in the blind bores 59, the device 1 is centered and anchored with respect to the mold 57. At the same time, the centering pins 26 are inserted in fitting holes on the press or the molding tool, so that each passage opening 16 equipped with a part lies exactly above a cavity 58 of the mold 57.

By extending the first cylinder piston units 43, the rotational movement of the first shaft 27 and second shaft 28 and thus the lowering movement of the platen 17 is continued until the lower second position is reached. In this third operating position of the device 1, the pins 25 completely penetrate the passage openings 16, thereby pushing the parts out of the passage openings 16 into the cavities 58.

To remove the device 1 from the press, the described steps are carried out in reverse order. After that, the device 1 is back in the first operating position and is ready for another production cycle. Concurrently, the molding tool can be closed, and the molded part can be produced in the known manner.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for loading prefabricated parts into a molding tool of a press for the production of molded parts, in particular for the production of elastomer molded parts, the device comprising:
a plate-like carrier element for attachment to the press, wherein the carrier element comprises a top and a bottom;
a holder to accommodate at least one interchangeable platen equipped with the parts, wherein the holder is arranged on the carrier element at a clear distance from its bottom and the interchangeable platen comprises a plurality of passage openings to accommodate the parts;
a platen comprising pins that is located between the bottom of the carrier element and the holding unit, wherein the pins align with the passage openings; and
a lowering device, via which the platen is lowered from an upper first position, in which the pins aligned with the passage openings maintain a clear distance to the at least one interchangeable platen, into a second lower position onto the at least one interchangeable platen, in which the pins penetrate the passage openings,
wherein the platen is adapted to be fixed in an intermediate position between the first position and the second position, and
wherein, in the intermediate position, the pins are arranged with their ends directly in the area of the parts placed in or on the passage openings for securing the parts.

2. The device according to claim 1, wherein the lowering device for lowering the platen comprises at least one actuator, which is controlled such that, during the lowering movement, the platen is fixed in the intermediate position between the upper first position and the lower second position.

3. The device according to claim 2, wherein the at least one actuator comprises a first cylinder piston unit and a second cylinder piston unit, wherein the stroke of the first cylinder piston unit causes the platen to lower from the first position into the intermediate position, and the stroke of the second cylinder piston unit causes the platen to lower from the intermediate position into the lower second position.

4. The device according to claim 3, wherein the first cylinder piston unit and second cylinder piston unit are coupled such that their equidirectional piston strokes add up.

5. The device according to claim 1, wherein the lowering device comprises at least one pressure module with a push rod, which is mounted longitudinally movable in the carrier element transversely to the bottom thereof and is force-locked with its lower end to the platen, and wherein the at least one actuator acts directly or indirectly on the push rod.

6. The device according to claim 5, wherein the at least one pressure module comprises a rocker arm which is rotatably mounted about an axis of rotation, wherein the at least one actuator is hinged to the one lever arm of the rocker arm and the upper end of the push rod is hinged to the other lever arm of the rocker arm.

7. The device according to claim 6, wherein the articulation point of the push rod on the other lever arm of the rocker arm is radially moveable with respect to the axis of rotation of the rocker arm.

8. The device according to claim 5, wherein the lowering device comprises at least two pressure modules spaced from each other, wherein the two rocker arms of the two pressure modules extend torque-proof on a common first shaft, which runs coaxially to the axis of rotation.

9. The device according to claim 5, wherein the lowering device comprises at least two further pressure modules, of which both rocker arms sit torque-proof on a common second shaft, which runs substantially parallel and at a lateral distance to the first shaft, as well as synchronizors with which the rotational movement of the first shaft is synchronized with the rotational movement of the second shaft.

10. The device according to claim 9, wherein the synchronizors each comprise a first lever seated torque-proof on the first shaft and a second lever seated torque-proof on second shafts as well as a tension-compression rod which connects the two levers in an articulated manner.

11. The device according to claim 1, wherein the platen for the detachable attachment of the pins comprises at least one carrier plate on which the pins are arranged, and wherein the at least one carrier plate is detachably attached to the platen.

12. The device according to claim 1, wherein the device comprises at least one supporting element for attaching and centering the device in bores on the press, wherein the at least one supporting element at its lower end comprises an expansion element, which is radially expandable with respect to the longitudinal axis of the at least one supporting element.

13. The device according to claim 1, wherein the platen and/or the at least one carrier plate and/or the at least one interchangeable platen comprise at least two, preferably at least three spaced slotted holes in each of which a centering pin engages, which, when centering the interchangeable platen with respect to the molding tool, interacts with fitting holes on the press or the molding tool, wherein the slotted holes are each aligned to the center of the at least one platen and/or to the center of the at least one carrier plate and/or to the center of the at least one interchangeable platen.

14. A press for the production of molded parts, the press comprising:
a molding tool with cavities into which in the course of the manufacturing process pre-fabricated parts are adapted to be loaded; and
a device according to claim 1.

15. A method for loading prefabricated parts into a molding tool of a press for the production of molded parts, in particular for the production of elastomer molded parts, wherein the parts are pressed into the molding tool by lowering pins from passage openings in an interchangeable platen, the method comprising:
equipping an interchangeable platen with the parts by placing or loading in each case a part onto or into a passage opening in the interchangeable platen;
securing the position of the parts in the passage openings by a first lowering of the pins up to or onto the parts;
placing the interchangeable platen with the position-secured parts onto the molding tool; and
loading the parts into the molding tool by a second lowering of the pins until the pins penetrate the passage openings.
